(19) United States
(12) Patent Application Publication
(10) Pub. No.: US 2007/0106683 A1
(43) Pub. Date: May 10, 2007

(54) Distributed database

(75) Inventors: David Grabelsky, Skokie, IL (US); Prasoon Saurabh, Naperville, IL (US); Ashish Sardesai, Schaumburg, IL (US); Kalpesh Savla, Woburn, MA (US)

Correspondence Address: ROBERT PLOTKIN, PC, 91 MAIN STREET, SUITE 204, CONCORD, MA, 01742-2527, US

(73) Assignee: 3Com Corporation

(21) Appl. No.: 11/269,330

(22) Filed: Nov. 8, 2005

(51) Int. Cl. G06F 7/00

(52) U.S. Cl. 707/102

(57) ABSTRACT

A system and method are provided for constructing and operating a distributed database. The system and method use multi-master replication and synchronization, whereby one or more central sites provide redundant database support of groupings of local sites. The correspondence of local primary database and its centrally-located secondary (redundant) partner is configured such that each primary-secondary pair is independent of every other pair. Replication and synchronization within each pair is thus achieved independently across all pairs.

### BACKGROUND

1. Field of the Invention

The present invention relates to database systems and, more particularly, to techniques for synchronizing and replicating distributed databases.

2. Related Art

Many networked computer systems support features, services, and applications that depend on one or more databases or database systems. A typical example is a system that supports features and services for end users, such as a packet-based telephony system. The database in such a system might be used to hold user account information. For a system that supports a deployment which spans multiple, disparate site locations, many aspects of the services and the servers that provide them may be distributed. That is, each of the multiple sites that comprise such a deployment may implement some or all of the system services and features locally, while still requiring coordination and interaction across sites that enable the aggregate systems and servers to act as a coherent whole.

One of the crucial tasks of a distributed database system is the replication and synchronization of data among the multiple sites and installations across the deployment. A common architecture for such a distributed database system is one in which several local sites, each with its own local database system, are grouped under a central site that hosts an aggregate database of all the local database systems. The overall layout and format of each local database might be identical, but the specific content of each applies to each local site. For example, each system might be formatted identically for user account data, but the database at each site might hold information specific only to users at that site. At the central site a large database may hold not only the aggregate of all the local systems but also data for users of the central site. The local database at each site might serve as the primary system for the users of that site, while the central system serves as a secondary, backup to each local site. Or the roles of primary and secondary systems may be reversed between the central and local sites. In either case, proper function depends on up-to-date, synchronized data content between the central site and each of the local sites.

A typical architecture for such a distributed database is characterized by a large, central database in which each local database is incorporated as a subset or partition. The central database may be thought of as identical in format to each of the local databases, but with an added dimension for partitioning the content and associated operations that apply to each contained subset. Although this may seem a natural approach to the problem of aggregating the local databases, it introduces certain complexities and interdependencies among partitions into the processes of replication, synchronization, and database upgrades. Problems that result from these complexities and interdependencies will be described in more detail below.

Before describing these problems, however, terminology used herein will be introduced. Note that the definitions of some of the database terms used here may differ from their common usage.

As used herein, the term “schema definition” refers to a construct consisting of a collection of methods, procedures, and data that defines the logical structure of a data management entity. The definition, as such, does not constitute an actual instance of the entity. The data are defined as one or more tables of records, lists of data structures, or other variables, parameters or attributes. The overall definition is devised to accommodate specific application needs, and usually includes compliance with one or more rules or conventions of the specific commercial-or free database system within which it is used.

As used herein, the term “schema instance” refers to a construct that instantiates a data entity according to a schema definition. Each schema instance maintains its own set of methods and procedures, as well as its own actual data table(s), lists, etc. To the extent that methods and procedures defined in the parent schema definition may share executable code, the distinction among schema instances between their respective sets of methods and procedures may be virtual. However, their stored/managed data are separate and distinct.

As used herein, the term “database instance” refers to an application that makes operational the management and-manipulation of data which are maintained in one or more schemas. A database instance may, for example, be implemented as a standalone database application, or as part of an integrated or networked system of database instances.

As used herein, the term “database server” refers to a specific server platform on which one or more database instances are implemented and made operational.

As used herein, the term “database system” refers to an application program and associated servers that provide a framework and support for integration of one or more database instances implemented on one or more database servers. A database system also provides tools for the design and construction of the underlying functional elements (e.g., schemas). A system may range, for example, from a single database instance on one server, to multiple database instances on multiple, networked servers.

Referring to FIG. 1, a generic schema definition 102 and corresponding example of a specific schema definition 104 is shown. More generally, various generic definitions are shown on the left-hand side of FIG. 1, with corresponding specific examples of such definitions on the right-hand side. Correspondences between the various elements in the figure are indicated by labeled arrows in the figures as follows.

The top-level definition concept, shown in the top left block 102, identifies tables of various types. Each table has a generic definition, as indicated by arrow 106, which points to a representative table definition 108. Table definition 108 defines one of the types of tables in the generic schema definition 102.

Tables are constructed of records, which in turn have defined structures as indicated by arrow 110, which points to a representative record definition 112. Record definition 112 defines a type of record for use in a table defined according to table definition 108.

One particular example of a top-level schema definition 104, pointed to by arrow 114, has an identified type, and contains actual named definitions (including table types). In the example shown in FIG. 1, the schema definition 104 defines a schema named SITE AUTH DATA, indicating that the schema definition 104 defines a schema for storing site authorization data that may be used, for example, in an IP telephony system.

Arrow 116 shows the correspondence of generic table definition 108 to an example table definition 118. Note that the multiple table entries 120 shown in the example table 118 are meant to indicate that the accommodation of multiple entries by an actual instance of the table is part of the definition 118. However, the definition 118 does not actually contain any table entries (or data).

Arrow 122 shows the correspondence of generic table definition 108 to another particular example of a table definition 124. The comment regarding multiple table entries 126 applies here as well.

Arrow 128 shows the correspondence of generic record definition 112 to another particular example a record definition 130. Arrow 132 shows the correspondence of generic record definition 112 to another particular example of a record definition 134.

Arrow 136 shows the correspondence of the placeholder 138 for the “Devices” table in the top-level definition 104 to the definition 118 of the “Devices” table. Arrow 140 shows the correspondence of the placeholder 142 for the “Users” table in the top-level definition 104 to the definition 124 of the “Users” table.

Arrow 144 shows the correspondence of the definition 120 of the “Devices” table and the definition 130 of the records contained in the table. Arrow 146 shows the correspondence of the definition 126 of the “Users” table and the definition 134 of the records contained in the table.

Note that in the example illustrated in FIG. 1, the implied formats and relationships between the structures and contents of a schema definition are illustrative. They are not intended to be exclusive or exhaustive.

Referring to FIG. 2, an example is illustrated of the relationship between schema definition and schema instance. More specifically, the example schema definition 104 shown in the top right-hand side of FIG. 1 is applied to the instantiation of two schema instances 202a-b. Each of the schema instances 202a-b contains actual data, which are defined according to the template schema definition 104. Each of the schema instances 202a-b also has its own unique name identifier. More specifically, schema instance 202a has name 204a, and schema instance 202b has distinct name 204b.

Referring to FIG. 3, example relationships between a database system 302, database servers 304a-b, and database instances 306a-c are shown as a hierarchy. At the top level, the database system 302 consists of one or more database servers 304a-b (two of which are shown in FIG. 3 for purposes of example). Each of the servers 304a-b hosts one or more database instances. In the example shown in FIG. 3, database server 304a hosts database instances 306a-b and database server 304b hosts database instance 306c.

Each of the database instances 306a-c implements one or more schema instances 308a-f. More specifically, database instance 306a implements schema instance 308a; database instance 306b implements schema instances 308b-d; and database instance 306c implements schema instances 308e-f. The schema instances 308a-f may be of any definition type; i.e., all the same, each different, or any mix. The system 302 also defines the rules for construction of the operational elements, and provides tools for their implementation. Note that the hierarchy shown in FIG. 3 is intended to illustrate the concepts and terms introduced above, and should not be considered to be exclusive or exhaustive.

The conceptual hierarchy shown in FIG. 3 provides a basis for explanation of a distributed database. The multiple database instances 306a-c and servers 304a-b allow data to be spread across multiple locations, while the overall database system 302 ensures that the separate elements act in concert. Interconnection 310 between the servers 304a-b may be achieved with a packet network, e.g., an IP network. The structure and format of the data depends on the specific deployment application. For the purposes of example in the present discussion, attention is focused on an organizational hierarchy in which each of one or more centralized sites is a parent or command center (in some sense) for its own set of local sites. The database instances maintained at each of the types of sites are largely (or entirely) of the same basic format (i.e., schema definitions), but the content of each site's database instance(s) is specific to that particular site. Further, each central site, in addition to containing its own site-specific data, is assumed to provide redundant database content and functionality for each of its local sites.

Of particular concern in such a deployment is the replication and synchronization of the database contents across sites that comprise redundant pairs. An example of such a deployment is illustrated in FIG. 4. Here, the central site 402 is identified as a “Headquarters,” and each of the local sites 404a-d is called a “Branch.” The specific label of “Headquarters Site 1” is meant to indicate that there could be more than one headquarters site in a particular deployment, each with its own set of branches. For the purpose of this discussion, however, only one such headquarters site 402 is shown.

Each of the sites 402 and 404a-d has a representative set of applications, services and features 406a-b and 408a-e (generically labeled in FIG. 4), as well as an associated database. More specifically, branches 404a-d have databases 410a-e, while the headquarters site 402 hosts a database 412 that is the aggregate of its own data and the data of all its branch sites 404a-d. The dashed arrows 414a-d connecting the databases 410a-e at the branches 404a-d to the headquarters database 412 signify data replication and synchronization between the databases at each end of the arrows 414a-d. At this point, nothing is being implied about the structure or architecture of the aggregate database 412, other than redundant content with each of the branch databases 410a-e. Note that the headquarters database 412 has its own redundant partner 412′ for backup. Also, the site 404d in this example includes a completely redundant system, including redundant databases 410d-e; this is shown merely as an example and is not a requirement of this type of configuration.

The nature of the applications and services 406a-b and 408a-e is not specified here, though the intent in this example is for a system that is capable of supporting both computer data processing/exchange and packet telephony (as represented by the generic computer and telephone icons 416 and 418a-d shown in FIG. 4). It is assumed that database services are part of the overall system, and that operation of the generically labeled servers and applications includes interaction with their associated databases. Further, the interconnection of the headquarters servers 406a-b with the branches 404a-d, represented by the long dashed lines 420 and 422a-d, is meant to indicate that the headquarters servers 406a-b are capable of providing redundant application and database support to users at each of the branch systems 404a-d. In doing so, the headquarters system 402 could interact with its aggregate database 412 as necessary, when referring to data that apply to a branch that is receiving redundant support from the headquarters 402. Such a configuration is exemplified in FIG. 4, with each of the branch systems 404a-d acting as the primary system for users at that branch (as indicated by the thick solid lines 424 and 426a-d between systems and user devices), while the headquarters system 402 serves as their secondary (backup) system (as well as the primary for headquarter users). However, the generic architecture shown in FIG. 4 could, for example, equally well represent a configuration in which the headquarters system 402 is the primary for all users, including branch users, while each of the branch systems 404a-d serves as the secondary (backup) for users at that branch. In either case, replication and synchronization between primary and secondary databases is required. As with the previous illustrations, the configuration shown in FIG. 4 is meant to be an example only. It should not be interpreted as exclusive or exhaustive.

The architecture of the databases 412 and 410a-e will now be described in more detail. In particular, the relationship between the branch databases 410a-e and the aggregate (headquarters) database 412, and its implications for data replication and synchronization, are examined.

The aggregate database 412 exemplified above as the headquarters database contains copies of the data in each of the local databases 410a-e, exemplified as branch databases. The structure of the aggregate database 412 is of interest because it impacts replication and synchronization between the aggregate 412 and local databases 410a-e, as well as data access operations by the headquarters application and services system 406a-b. One common way to organize such an aggregate system is to construct a large schema instance (based on a corresponding schema definition) by effectively concatenating the constituent, local schema instances. Within the large schema instance, the data corresponding to each branch-site schema instance can be viewed as a subset or partition of the aggregate. Hence this architecture for the aggregate schema instance is referred to as a partitioned schema. (The architecture is also sometimes called a partitioned database, but the term partitioned schema will be used here.)

The concept of a partitioned schema is illustrated in FIG. 5. A database instance 502 identified as “User Accounts” 504 in this example is seen to include a set of functions and structures 506, labeled “DB Instance Internals,” and a partitioned schema instance 508 labeled “User Data Schema.” The internals 506 are general structures and functions that support operation of the database 502 without regard to the specifics of the data maintained in the customized schema instance 508, associated in this example with user data of some sort. The partitioned schema instance 508 is represented as a concatenation of schema instances 510a-n for each of the branch sites; they are labeled “Partition: Site 1,” “Partition: Site 2,” and so on.

The integration of the individual branch site schema instances 510a-n as partitions in the aggregate (partitioned) schema instance 508 has important implications for database access operations, as well as for data replication and synchronization between the partitions 510a-n and the branch site schema instances. Any data access operation (read or write) must be able to identify the branch site to which the operation applies. For a single branch site, the identity is implicit, since each branch database instance is associated only with that site. In the aggregate database 412, the branch identity must be associated with a partition. This may be simply a matter of managing partitions according, e.g., to indices or keys, and associating each of the branches 404a-d with an index or key in the partitioned schema instance 508. No particular complexity is necessarily introduced with this method of schema access, although, depending upon the number and size of the partitions, the aggregate could grow large.

The use of a partitioned schema can, however, introduce certain complexities in connection with management of sites, as well as modifications and upgrades to the format of the schema instances (as determined by the schema definitions). FIG. 6 illustrates the correspondence between each of the partitions 510a-n in the aggregate schema 508 and the corresponding one of the schemas 608a-n at each of the branch sites 404a-n. In this example system, each of the branch systems 408a-e implements one database instance, each with a single schema instance for the customized data (“User Data” in FIG. 6). The associations between branch schemas 608a-n and partitions 510a-n is indicated by the dashed double arrows 610a-n. If a branch site is removed, then its partition must also be removed. Similarly, if a new site is added, then a partition must be added. And if the schema definition 104 for branch sites 404a-d is modified, then all the partitions 510a-n must be updated, along with the schema instance at each of the corresponding branch sites 404a-d. The complexities associated with these operations may manifest in a number of ways, but particularly in the process of data replication and synchronization. While any operation to upgrade or modify the structure and format of the partitioned schema and each individual branch schema is in progress, the overall system will be in a sort of hybrid state with some portions updated and others not. During this time, the nature of the partitioned schema 508 introduces an interdependency between sites 404a-d by effectively imposing this hybrid state on all sites 404a.-d. Under these circumstances, the failure of any one branch site to successfully synchronize with its partition in the headquarters site 402 may impact operation of the entire system 302. Depending upon the number of branch sites and corresponding partitions, upon the relative locations of the branch sites and headquarters, and upon the type of network interconnectivity between them, the effects of these interdependencies may be more or less severe.

What is needed, therefore, are improved techniques for managing distributed database systems.

### SUMMARY

A system and method are provided for constructing and operating a distributed database. The system and method use multi-master replication and synchronization, whereby one or more central sites provide redundant database support of groupings of local sites. The correspondence of local primary database and its centrally-located secondary (redundant) partner is configured such that each primary-secondary pair is independent of every other pair. Replication and synchronization within each pair is thus achieved independently across all pairs.

In one embodiment, a computer-implemented database system is provided which includes a plurality of database instances comprising a first plurality of schema instances, each of the plurality of database instances including at least one of the first plurality of schema instances; and an aggregate database instance comprising a second plurality of schema instances, each of the second plurality of schema instances corresponding to at least one of the first plurality of schema instances.

In another embodiment, an aggregate database instance in a computer system is provided. The computer system includes a plurality of database instances. The plurality of database instances includes a first plurality of schema instances. Each of the plurality of database instances includes at least one of the first plurality of schema instances. The aggregate database instance includes a second plurality of schema instances. Each of the second plurality of schema instances corresponds to at least one of the first plurality of schema instances.

In yet another embodiment, a computer-implemented method is provided for use with a computer system. The computer system includes a plurality of database instances and an aggregate database instance including a plurality of elements corresponding to the plurality of database instances. The method includes synchronizing a first one of the plurality of database instances and a first one of the plurality of elements in the aggregate database instance without interrupting operation of any other ones of the plurality of database instances.

In still a further embodiment, a computer-implemented method is provided for use with a computer system. The computer system includes a plurality of database instances and an aggregate database instance including a plurality of elements corresponding to the plurality of database instances. The method includes (A) performing a first modification to a first one of the plurality of database instances; and (B) performing a second modification to a first one of the plurality of elements, the first and second modification being equivalent. Both (A) and (B) are performed without modifying any of the plurality of elements except for the first one of the plurality of elements.

Other features and advantages of various aspects and embodiments of the present invention will become apparent from the following description and from the claims.

### BRIEF DESCRIPTION OF THE DRAWINGS

FIG. 1 is a diagram illustrating a generic schema definition and a corresponding example of a specific schema definition;

FIG. 2 is a diagram illustrating an example of the relationship between a schema definition and a corresponding schema instance;

FIG. 3 is a diagram illustrating relationships between a database system, database servers, and database instances;

FIGS. 4A-4B are diagrams illustrating a database system including content distributed across sites that comprise redundant pairs;

FIG. 5 is a diagram illustrating a partitioned schema;

FIG. 6 is a diagram illustrating the correspondence between each of the partitions in an aggregate schema and the corresponding one of the schemas at branch database sites;

FIG. 7 is a diagram illustrating the structure of an aggregate database using a multi-master approach according to one embodiment of the present invention;

FIG. 8 is a diagram illustrating the association of an aggregate database instance with each of several branch-site database instances according to one embodiment of the present invention;

FIGS. 9A-9B are diagrams illustrating an example of an architecture for a packet telephony system using a distributed multi-master approach according to one embodiment of the present invention;

FIGS. 10A-10B are diagrams illustrating an example of an architecture similar to that shown in FIG. 9 except that a backup is provided for the aggregate database according to one embodiment of the present invention;

FIGS. 11A-C are flowcharts of methods that may be used by the architectures of FIGS. 9-10 to synchronize and/or update database instances without interrupting operation of other database instances in the system.

### DETAILED DESCRIPTION

Embodiments of the present invention implement an alternative architecture that largely mitigates the complexities inherent in the partitioned approach described above. More specifically, and as described above, a typical architecture for a distributed database is characterized by a large, central database in which each local database is incorporated as a subset or partition. In contrast, and in accordance with various embodiments of the present invention, the central database may be implemented as a collection of independent copies of each of the local databases, rather than an integration of partitions. More specifically, the correspondence of local primary database and its centrally-located secondary (redundant) partner may be configured such that each primary-secondary pair is independent of every other such pair. Replication and synchronization within each pair is thus achieved independently across all pairs. Since each local-central pair in this approach is comprised of two equivalent databases, the term multi-master is used to describe this architecture. As will be described in more detail below, the multi-master architecture reduces the complexities and breaks the interdependencies among local databases that is inherent in the conventional partitioned approach described above.

For example, schema instances may be duplicated in such a way that a single (or relatively few) aggregate database instance(s) contains multiple, independent schema instances, each of which corresponds to a schema instance at one of the branch sites. Keeping multiple schema instances within one database instance preserves the operational efficiency and manageability of the overall system, and facilitates scalability on a par with partitioned schema systems. Because replication and synchronization between each individual site schema instance and its partner schema in the aggregate database is symmetrical with respect to the direction in which schema updates propagate, this approach is termed multi-master schemas.

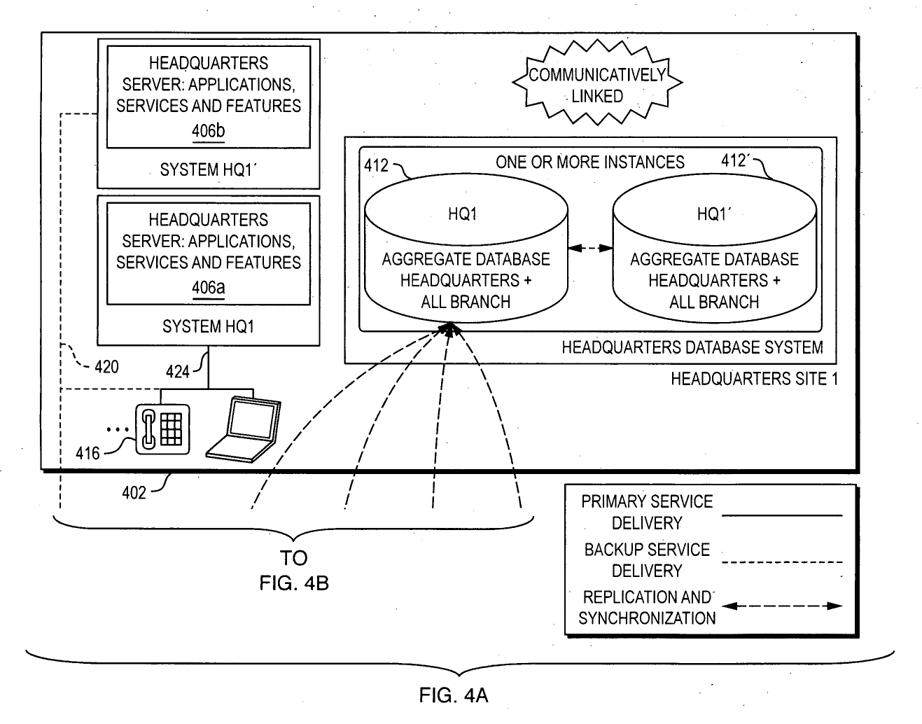

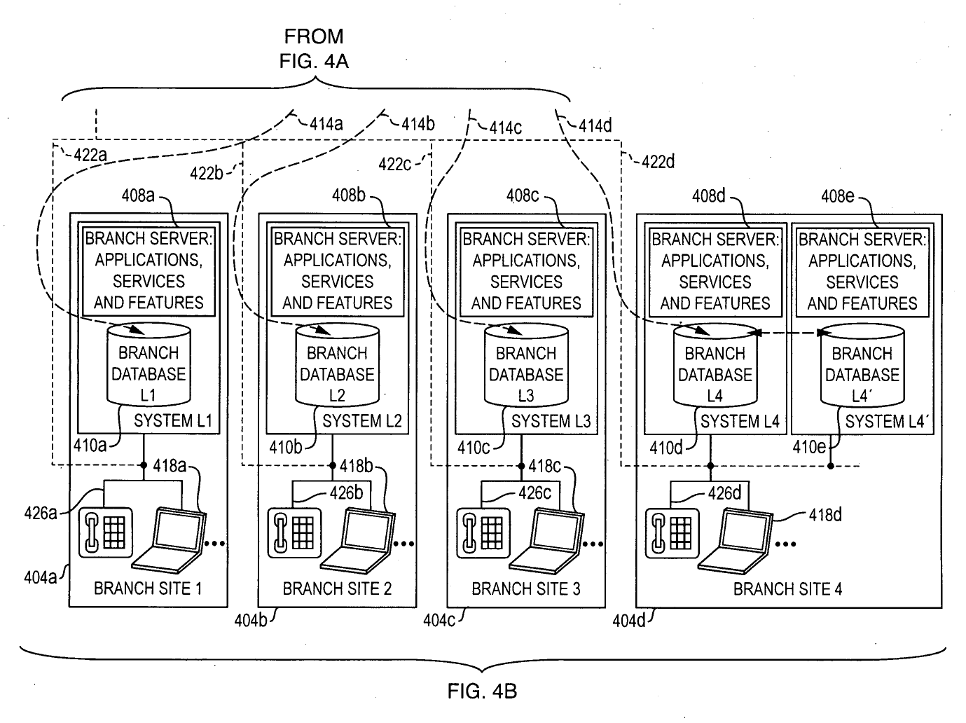

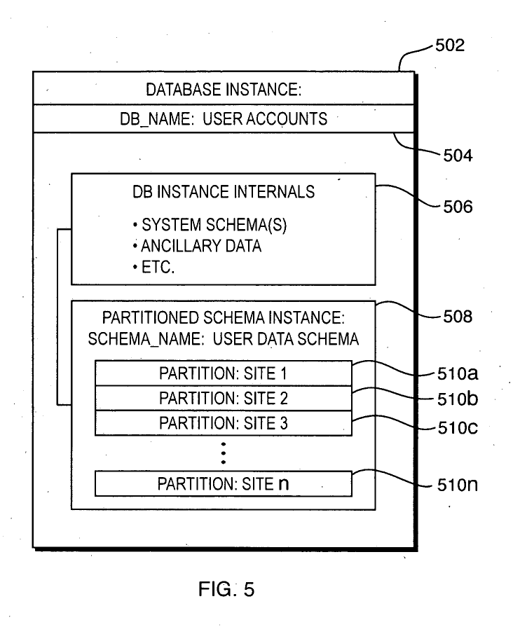

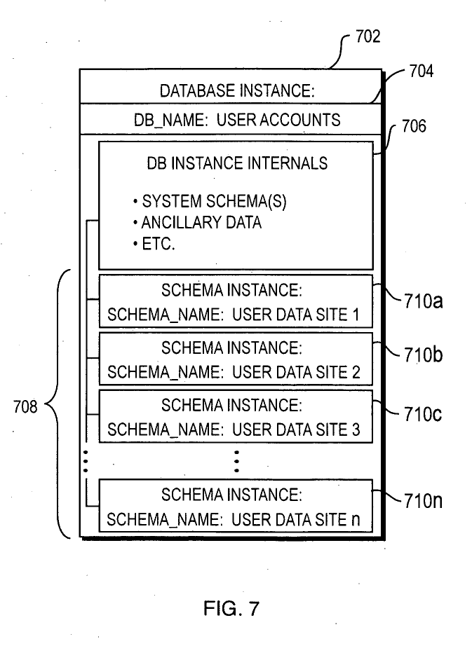

The structure of the aggregate database in the multi-master approach according to one embodiment of the present invention is illustrated in FIG. 7. Although the schema instance 708 in FIG. 7 is similar to the schema instance 508 in FIG. 5, each of the partitions 510a-n in FIG. 5 is implemented as a separate schema instance (i.e., schema instances 710a-n) in FIG. 7. As with the partitioned case, data access operations (read or write) on the aggregate database instance 702 must be able to identify the branch site to which the operation applies. Once identified, the branch identity is now associated with a distinct schema instance, rather than a partition. For example, the branch 404a shown in FIG. 4 may be associated with schema instance 710a, while branch 404b may be associated with schema instance 710b, and so on. The complexity of this method for data access operations on the aggregate database instance 702 is not significantly greater or lesser than that for the partitioned schema 508. However, replication and synchronization operations can benefit from the multi-master approach.

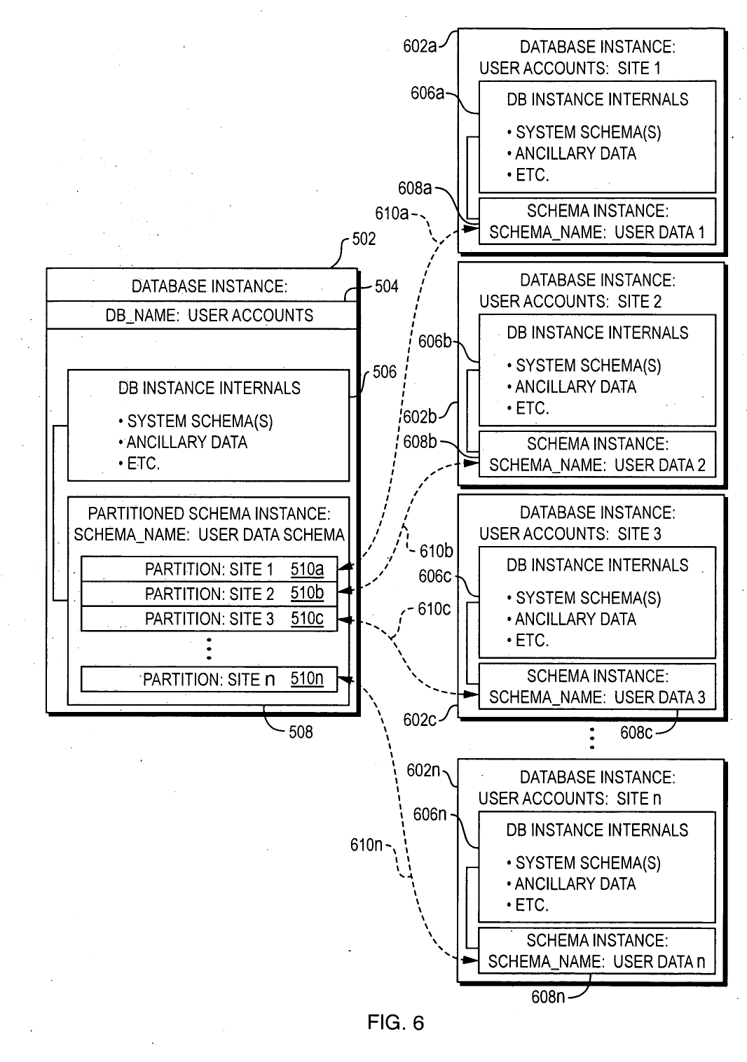

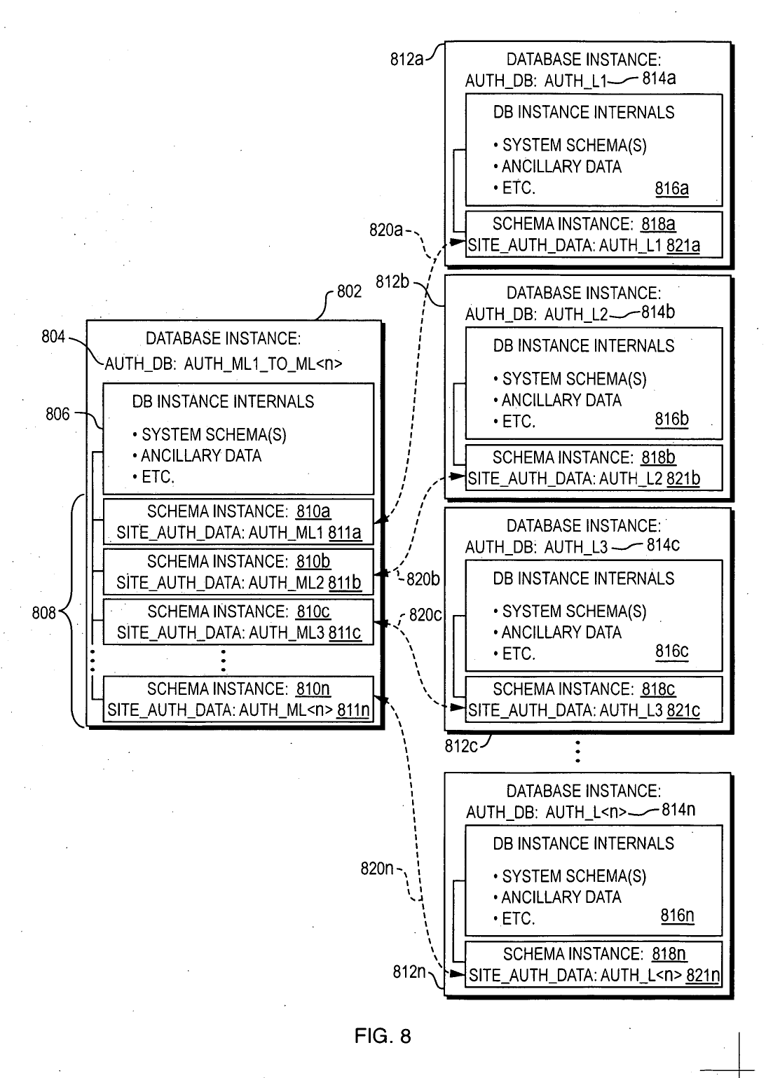

FIG. 8 shows the association of an aggregate database instance 802 with each of several branch-site database instances 812a-n. The dashed double arrows 820a-n show the correspondence between schema instances 818a-n at each individual site and schema instances 810a-n in the aggregate database instance 802. Because separate schema instances 810a-n are used in the aggregate 802, data replication and synchronization operations between the aggregate 802 and each of the individual sites 812a-n are decoupled. That is, the interdependencies that characterize the partitioned model (FIG. 6) are eliminated in this multi-master model (FIG. 8). The schema instances 810a-n and 818a-n at each end of a given dashed double arrow in FIG. 8 both represent master copies of the contained data. Replication and synchronization between each master is symmetrical, and independent of every other arrow-connected pair. For example, replication and synchronization between schema instance 810a and schema instance 818a is symmetrical and independent of the pairs consisting of schema instances 810b and 818b, 810c and 818c, and 810n and 818n.

The symmetry allows changes to propagate in either direction: from the aggregate element (e.g., 810a) to the site element (e.g., 818a), or vice versa. While the partitioned model (FIG. 6) can similarly support bi-directional replication and synchronization, in the multi-master model (FIG. 8), the operation is identical in either direction. The independence also means that individual pairs can be subject to replication or synchronization operations without impacting any other pairs. In particular, the failure of the operation on any given pair has no impact on the remaining pairs. Note that from a system perspective, during the time that an upgrade to structure or format is be rolled out in the multi-master model, the system is in hybrid state, similarly to such operations in the partitioned model. But the hybrid state in the multi-master model does not affect each schema pair as it does in the partitioned model. The reason is that in the partitioned model, the entire set of partitions 510a-n in the aggregate database 502 must be upgraded prior to synchronizing with the individual site databases 602a-n. Thus the partitioned system truly is hybrid. By contrast, in the multi-master case, each of the schema instances 810a-n in the aggregate 802 may be upgraded, and its site-based partner (818a-n) synchronized, independently. The hybrid nature in the multi-master model is just a mix of pre- and post- (and in-progress) upgrades.

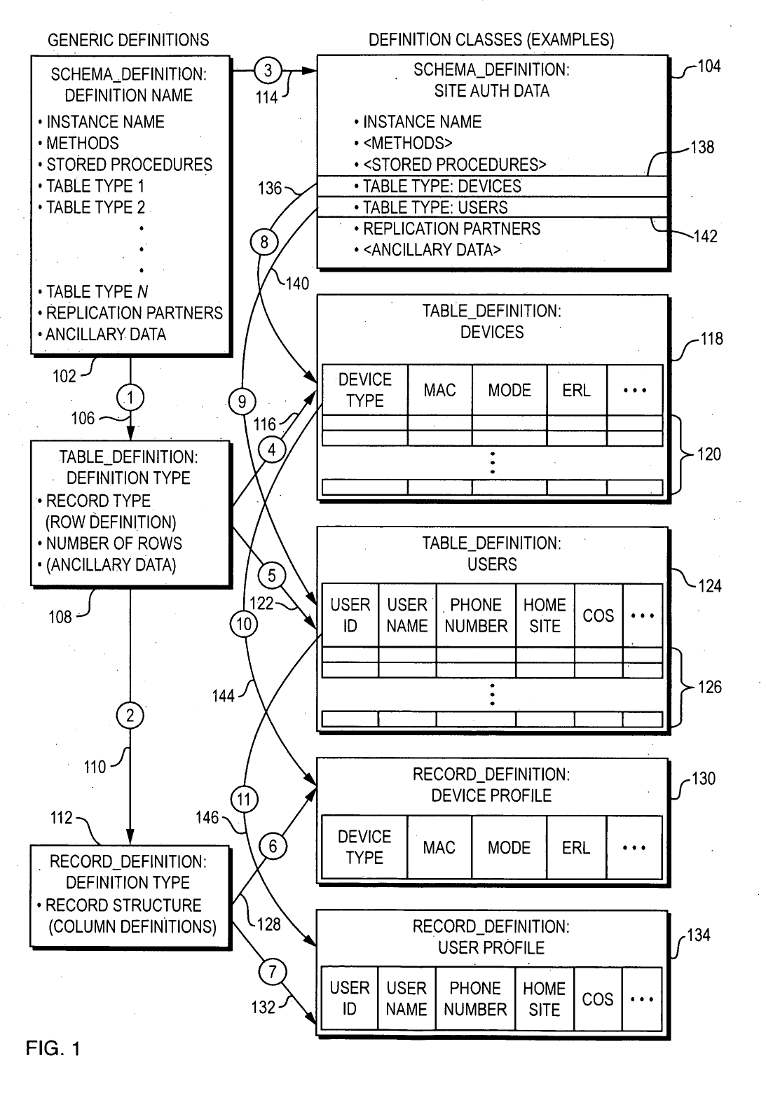

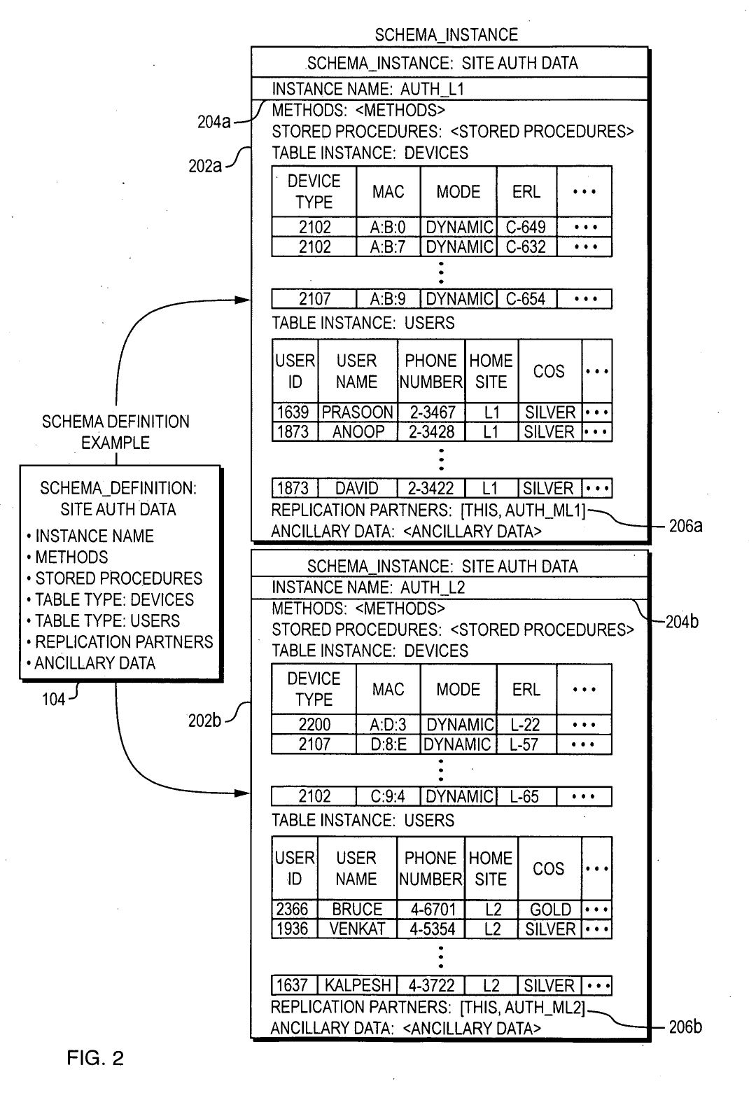

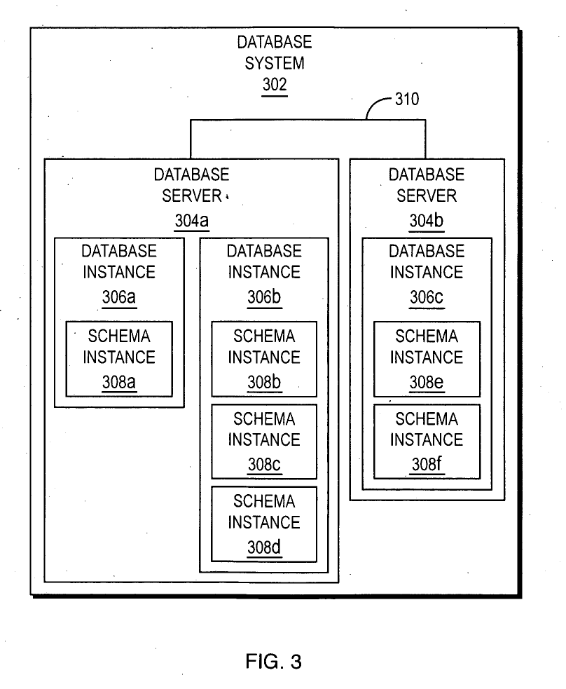

The name identifiers 804 and 814a-n of the database instances 802 and 812a-n in the example in FIG. 8 refer back to the illustrations of schema definitions and schema instances shown in FIGS. 1 and 2. The particular example illustrated in FIG. 8 applies the multi-master model described above to an example IP telephony system. As the naming convention used in FIG. 8 also suggests, although only one aggregate database 802 is shown in FIG. 8, multiple aggregate database instances may be implemented. Thus the name of the aggregate 802, “Auth_ML1_to_ML<n>,” indicates that this database instance 802 contains schema instances 810a-n for sites i to n. As illustrated in FIG. 3, a distributed database system may include more than one database instance. The reasons for using more than one database instance for the aggregate may include, for example, size and scaling considerations, performance issues, or geographic locations of sites. The independence of the schema pairs helps reduce the complexity of using multiple database instances.

The use of the term “Auth” in the names 804, 814a-n, 811a-n, and 824a-n of the database instances 802, 812a-n and schema 810a-n and 818a-n in FIG. 8 suggest association with some sort of authorization and authentication process. This is a common requirement of many systems that provide services to end users. FIGS. 1 and 2 use the same term in illustrating schema definitions and schema instances. Referring again to these figures, the example data definitions and values suggest a database and schema that manages specific IP telephony devices, as well as specific end users. In addition, each schema instance in FIG. 2 includes a data item called “Replication Partners.” This represents one way the multi-master partners discussed above may be identified in this method. For example, the schema instance 202a for site L1 (top of FIG. 2) identifies its replication partners 206a as itself (“this”) and “Auth_ML1.” Compare this stored configuration information with the top of FIG. 8, which shows the correspondence between the site schema instance “Auth_L1” 818a and the aggregate-based schema instance “Auth_ML1” 810a. Finally, note that the number of schema instances grouped as replication partners is not necessarily restricted to two. It is possible, rather, for three or more schema instances all to be partners in a multi-master group.

As with the other examples shown here, the ones shown in FIGS. 7 and 8 are intended merely as examples and not to be exclusive or exhaustive.

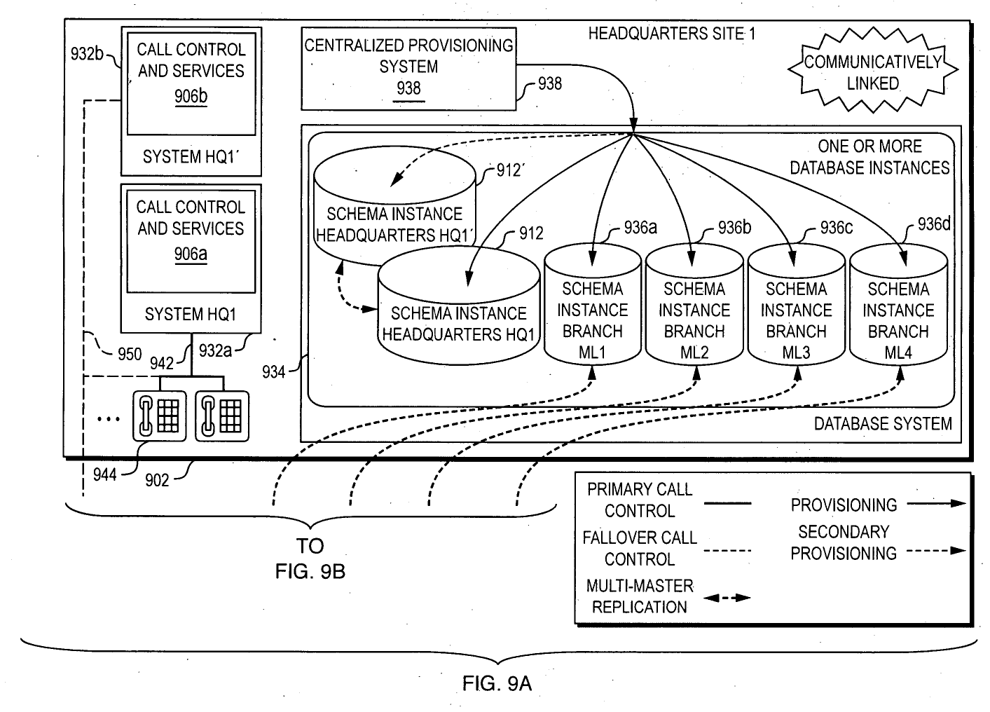

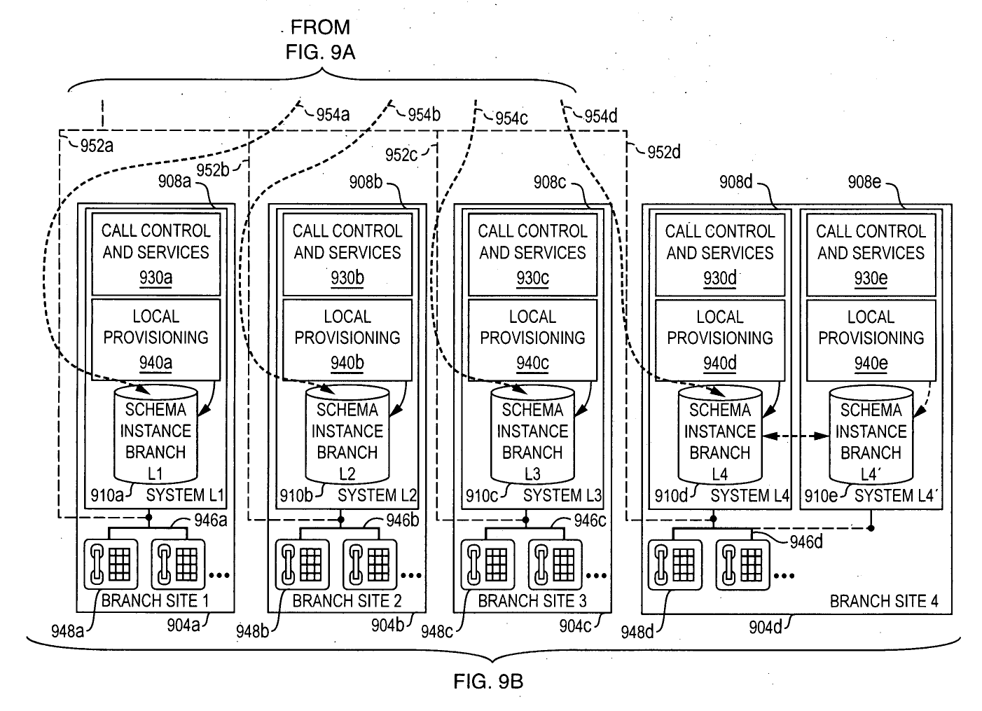

An example of an architecture for a packet (IP) telephony system using a distributed, multi-master approach is illustrated in FIG. 9. The intent of such an architecture is to provide support for an enterprise that has one or more headquarters and multiple branch locations. Each branch has its own telephony system and a database instance for storing data about users at that branch. In this particular example, when a user places a call from a telephone at a branch location, the telephone attempts to communicate with the local (branch) database. If the attempt fails, the phone attempts to communicate with the remote (headquarters) database as a backup. This backup mechanism is transparent to the user.

Four branch sites 904a and one headquarters site 902 are shown in FIG. 9 for purposes of example. Each branch site has its own local system that includes a component for call control and services, and a local database with a site-specific schema instance (“L1,” etc.). More specifically, branch sites 904a-e include components 930a-e, respectively.

In this example, “Branch Site 4” 904d includes a completely redundant system, including redundant databases 908d-e. The headquarters site 902 has a primary system 932a and secondary (backup) system 932b, and hosts a database instance 934 that contains redundant schema instances 936a-d for the branch sites 904a-d, as well as primary 912 and secondary 912′ schema instances for users at the headquarters. Each site (branch and headquarters) also includes a component called “Provisioning System.” More specifically, headquarters site 902 includes a centralized provisioning system 938, and branch sites 904a-d include local provisioning systems 940a-e. In a user-services system such as the IP telephony system of this example, each provisioning system provides a user interface to the corresponding database system for such operations as adding new users, adjusting users' privileges, adding new devices, customizing service features, etc. In the context of a provisioning system, the user may, for example, be an end user or an administrator.

As with the generic architecture shown in FIG. 4, each of the local branch sites 904a-d serves as the primary system for the users at that branch (as indicated by the thick solid lines 942, 946a-d between the systems 932a-b, 908a-e and the phones 944, 948a-d), while the headquarters site 902 serves as the backup system for branch users (as indicated by the long dashed lines 950, 952a-d). Under nominal conditions, a user's primary system would provide IP telephony services, such as call processing and feature delivery (e.g., call-waiting, call forwarding, etc.). The user's primary system would consult the associated database for any requisite information, such as authorization of a service or feature for that user. More specifically, for an SIP-based system, the database might be consulted when a user registers at an SIP-based phone device. If a branch-site system were to fail, the secondary system at the headquarters 902 could automatically assume the service tasks for all users of that branch site. In doing so, the secondary system could then consult the replicates (and synchronized) copy of the branch-site data that are maintained at the headquarters. Note that the assignments of primary and secondary systems to branch and headquarters, respectively, may be design or configuration considerations. As with the partitioned model, the roles of primary and secondary could be reversed between the branch and headquarter systems.

Regardless of how primary and secondary systems are established, the databases at each must be maintained in a state of synchronization. The dashed double arrows 954a-d between the schema instances in each branch and the schema instances 936a-d in the headquarters database instance 934 in FIG. 9 show the multi-master pairing of the respective schema instances 936a-d. The database operations that would result in a needed synchronization operation include modification of existing data elements, addition and/or deletion of data elements according to existing data definitions, and upgrades to the schema definitions themselves. Examples of data element modification might include changing the phone number assigned to a user, changing a user's registration state (e.g., on-line to off-line), and changing a user's calling privileges (e.g., allowing/disallowing long-distance calls, etc.). Examples of adding or deleting data elements might include adding (deleting) a new (existing) user, adding (deleting) a new (existing) branch site, and adding (deleting) a new (existing) device type. An example of upgrading a schema definition might be adding (removing) a new (existing) definition for a data type or attribute to a user account schema (e.g., “class of service” attributed added or deleted from a schema definition). The first two kinds of schema changes, modifications and additions/deletions, may be limited to just a single schema instance. They might result from actions taken via the provision system 938, 940a-e shown in the example in FIG. 9, or the call control system could make them (e.g., updating a user's registration state). Such changes would require synchronization only with the multi-master partner(s) of the effected schema instance. The third kind of change, upgrades to the schema definition, effects all schema instances of that definition type. In this case, all effected schema instances must be upgraded according to the new definition. The operations that achieve all three kinds of changes benefit from the multi-master architecture by virtue of the decoupling of each multi-master pair (or group) from every other during the actions and communications that comprise the change operations. Again, the dashed double arrows 954a-d in FIG. 9 emphasize this decoupling.

The examples associated above with each of the different kinds of changes to the contents of the schema instances are not meant to be exclusive or exhaustive.

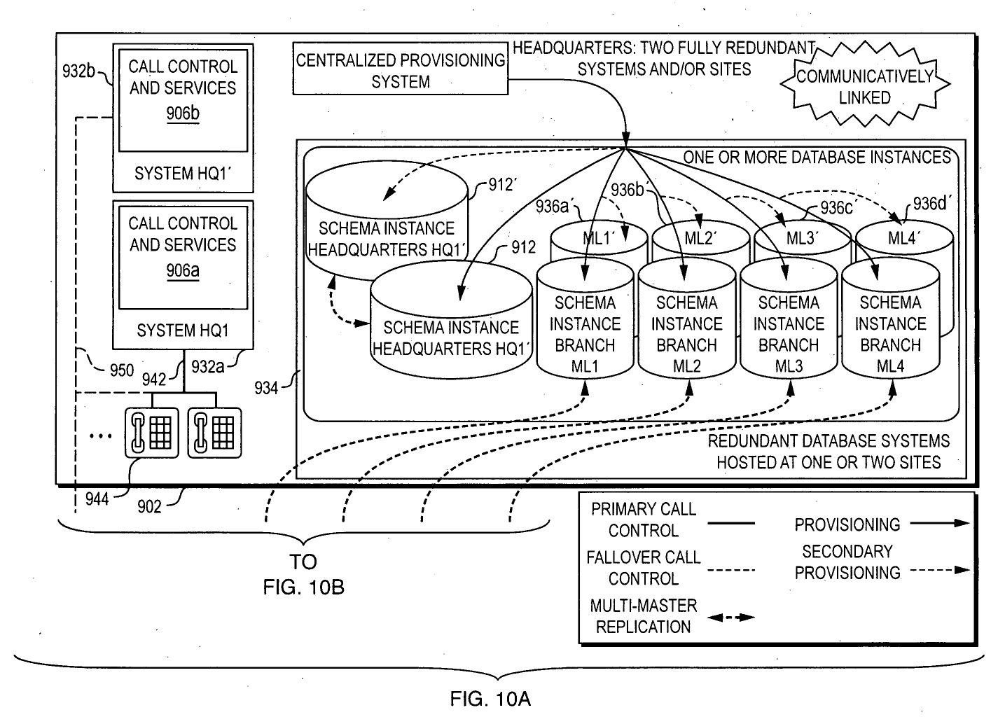

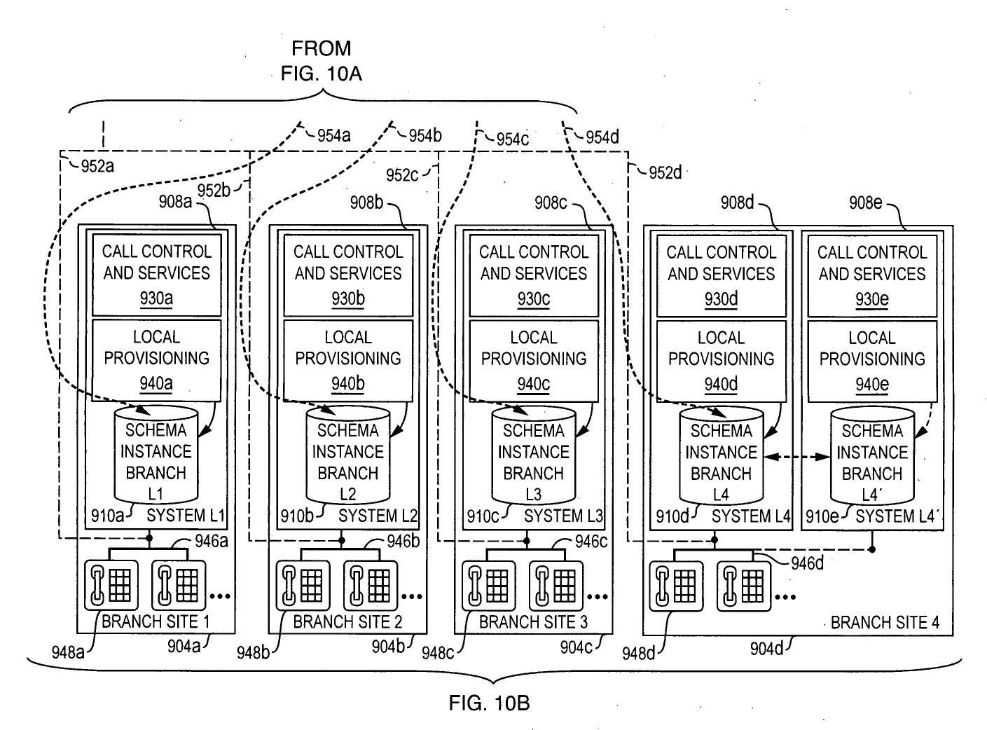

The headquarters site in FIG. 9 has primary and secondary systems 932a and 932b (“HQ1” and “HQ1′”), as well as primary and secondary schema instances for users at the site (912 and 912′). The intent is to provide the same sort of backup to headquarters users that the headquarters site 902 provides for the branch site users. In order to provide an additional layer of redundancy for the branch sites, there could be a backup for the aggregate database 934. Such a configuration is shown in FIG. 10, where the backup schema instance for each branch site has its own backup; e.g., “ML1” 936a and “ML1′” 936a′. In the example in FIG. 10, the term “Mirror Backup” is used to describe this arrangement. The means by which such backup is created and maintained may or may not be different from the replication and synchronization that is used between multi-master pair (or group) elements.

Finally, if multiple headquarters sites are deployed, then there may be replication and synchronization of each headquarters' database instances and schema instances across these sites. Again, use of the multi-master model allows the decoupling that helps minimize the complexity of operation that can characterize the partitioned model.

All of the architecture examples of multi-master synchronization shown and described herein are not intended to be exclusive or exhaustive. Furthermore, the application of the multi-master model to an IP telephony system is as an example and is not intended to limit the scope of application of the multi-master model in general.

Among the advantages of the invention are one or more of the following. In general, the multi-master architecture reduces the complexities and breaks the interdependencies among local databases that is inherent in the conventional partitioned approach described above. The resulting system is less complex and more robust than so-called partitioned databases, in which the centralized system is an integrated aggregate of all the local databases. For example, the multi-master architecture enables portions of the aggregate data that are shared by more than one installation or site to remain synchronized.

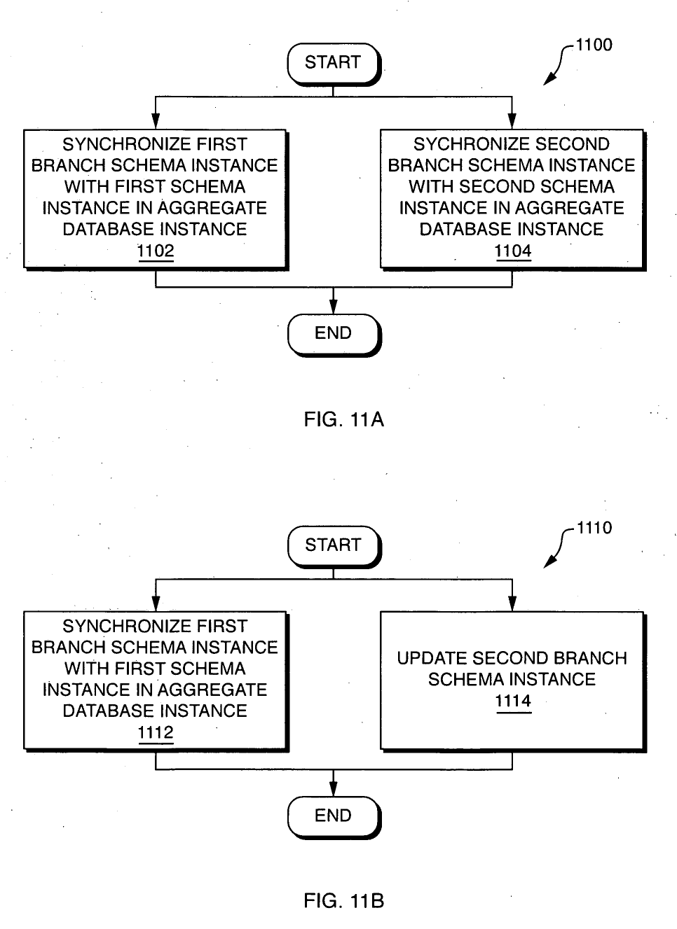

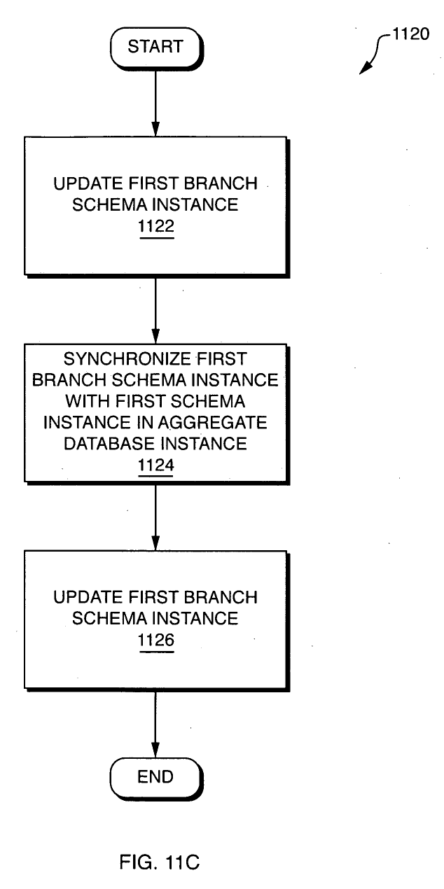

Furthermore, the multi-master architecture makes it possible to make incremental updates to the database at any of the installations or sites. Each branch database may be updated independently of the others, without the need to bring down the entire database system. For example, referring to FIGS. 1A-C, flowcharts are shown of methods that may be used by the architectures of FIGS. 9-10 to synchronize and/or update database instances without interrupting operation of other database instances in the system. Referring to FIG. 11A, a method 1100 is shown in which a first branch schema instance (e.g., schema instance 910a) is synchronized with a first schema instance in the aggregate database (e.g., schema instance 936a) (step 1102). A second branch schema instance (e.g., schema instance 910b) is synchronized with a second schema instance in the aggregate database (e.g., schema instance 936b) (step 1104). Steps 1102 and 1104 are shown in parallel to indicate that these steps operate independently of each other and that there is no necessary temporal relationship between them. The ability to perform the first synchronization operation (step 1102) without interrupting the second synchronization operation (step 1104) flows from the use of the multi-master architecture described above.

Similarly, one pair of partner schema instances may be synchronized while another schema instance is updated, without either of the two operations interrupting the other. For example, referring to FIG. 11B, a method 1110 is shown in which a first branch schema instance (e.g., schema instance 910a) is synchronized with a first schema instance in the aggregate database (e.g., schema instance 936a) (step 1112). A second branch schema instance (e.g., schema instance 910b) is updated (step 1114). Steps 1112 and 1114 are shown in parallel to indicate that these steps operate independently of each other and that there is no necessary temporal relationship between them. The ability to perform the synchronization operation (step 1112) without interrupting the update operation (step 1114) flows from the use of the multi-master architecture described above.

Similarly, one branch schema instance may be updated and then synchronized before updating another branch schema instance. In other words, it is not necessary to update all branch schema instances before synchronizing them. Referring to FIG. 11C, a method 1120 is shown in which a first branch schema instance (e.g., schema instance 910a) is updated (step 1122) and the first branch schema instance is synchronized with a first schema instance in the aggregate database (e.g., schema instance 936a) (step 1124) before updating a second branch schema instance (e.g., schema instance 910b) (step 1126). The ability to perform the first update and synchronization operations (steps 1122-1124) before performing the second update operation (step 1126) flows from the use of the multi-master architecture described above.

In contrast, in database systems having a single schema, it is typically necessary to bring down the entire schema before updating it. In contrast, in embodiments of the present invention, the central database can continue running while one or more of the local databases are being updated. As a result, database updates may be performed with zero downtime.

As a result of the ability to perform independent updates, the techniques disclosed herein make it possible to roll out more significant updates and/or upgrades to the aggregate system in a non-disruptive manner. This includes resiliency of the overall system during site-by-site upgrades, even in the event that individual site upgrades do not successfully complete. Furthermore, the same ability makes it possible to have mixed-version database systems. For example, some branches may run version 1.0 of a database while other branches run version 2.0 of the database. In such a case, some schema instances would be defined according to one schema definition, while other schema instances in the same database system would be defined according to another schema definition. This capability may be beneficial, for example, for controlling the cost of updating, for staging the timing of updating, or for other reasons.

The techniques disclosed herein are particularly useful in contexts, such as IP telephony, in which a real-time database system is desirable or necessary. For example, when a user attempts to place a telephone call, it is necessary to access the database to determine whether the call is allowed. Because such an operation is time critical, it is important to maintain database synchronization at a relatively high frequency. The techniques disclosed herein, by enabling database synchronization to be performed independently for each local database instance, are particularly well-suited for time-critical and mission-critical applications.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques disclosed herein may be used in conjunction with any of a variety of database systems. One example of a commercial database system with which the techniques disclosed herein may be implemented is Oracle Database version 8i. Such a database system provides support for performing functions described herein, such as database synchronization, replication, and updating. Furthermore, such a database system provides features such as Oracle object support for creating multiple branch schemas and distributed object synching that may be used to implement features disclosed herein, such as multimaster replication. Those having ordinary skill in the art will appreciate how to use this or other database systems to implement the features disclosed herein.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented database system comprising:
a plurality of database instances comprising a first plurality of schema instances, each of the plurality of database instances including at least one of the first plurality of schema instances; and
an aggregate database instance comprising a second plurality of schema instances, each of the second plurality of schema instances corresponding to at least one of the first plurality of schema instances.

2. The database system of claim 1, wherein the aggregate database instance includes a partition that does not include sub-partitions, and wherein the partition includes the second plurality of schema instances.

3. The database system of claim 2, wherein the aggregate database instance includes the partition and no other partitions.

4. The database system of claim 1, wherein each of the second plurality of schema instances corresponds to exactly one of the first plurality of schema instances, and wherein no two of the second plurality of schema instances correspond-to the same one of the first plurality of schema instances.

5. The database system of claim 1, wherein each of the second plurality of schema instances comprises substantially a copy of the corresponding at least one of the first plurality of schema instances.

6. The database system of claim 5, further comprising:
means for synchronizing each of the second plurality of schema instances with the corresponding at least one of the first plurality of schema instances.

7. The database system of claim 6, wherein the means for synchronizing comprises:
first synchronization means for synchronizing a first one of the second plurality of schema instances with a corresponding first one of the first plurality of schema instances; and
second synchronization means for synchronizing a second one of the second plurality of schema instances with a corresponding second one of the first plurality of schema instances, wherein the first synchronization means operates independently of the second synchronization means.

8. The database system of claim 6, wherein the first synchronization means comprises means for synchronizing the first one of the second plurality of schema instances with the corresponding first one of the first plurality of schema instances without interrupting operation of the second one of the second plurality of schema instances or the corresponding second one of the first plurality of schema instances.

9. The database system of claim 1, further comprising:
first modification means for performing a first modification to a first one of the first plurality of schema instances;
second modification means for performing a second modification to a first one of the second plurality of schema instances without modifying any other ones of the second plurality of schema instances, the first and second modification being equivalent.

10. The database system of claim 9, wherein the first one of the first plurality of schema instances and the first one of the second plurality of schema instances implement a first schema definition;
wherein the first modification means comprises means for updating the first one of the first plurality of schema instances to implement a second schema definition that differs from the first schema definition; and
wherein the second modification means comprises means for updating the first one of the second plurality of schema instances to implement the second schema definition.

11. The database system of claim 9, wherein the first modification means comprises means for modifying contents of the first one of the first plurality of schema instances, and wherein the second modification means comprises means for modifying contents of the first one of the second plurality of schema instances.

12. An aggregate database instance in a computer system, the computer system including a plurality of database instances, the plurality of database instances comprising a first plurality of schema instances, each of the plurality of database instances including at least one of the first plurality of schema instances, the aggregate database instance comprising:
a second plurality of schema instances, each of the second plurality of schema instances corresponding to at least one of the first plurality of schema instances.

13. The aggregate database instance of claim 12, further comprising a partition that does not include sub-partitions, and wherein the partition includes the second plurality of schema instances.

14. The aggregate database instance of claim 13, wherein the aggregate database instance includes the partition and no other partitions.

15. The aggregate database instance of claim 12, wherein each of the second plurality of schema instances corresponds to exactly one of the first plurality of schema instances, and wherein no two of the second plurality of schema instances correspond to the same one of the first plurality of schema instances.

16. The aggregate database instance of claim 12, wherein each of the second plurality of schema instances comprises substantially a copy of the corresponding at least one of the first plurality of schema instances.

17. The aggregate database instance of claim 16, further comprising:
means for synchronizing each of the second plurality of schema instances with the corresponding at least one of the first plurality of schema instances.

18. The aggregate database instance of claim 17, wherein the means for synchronizing comprises:
first synchronization means for synchronizing a first one of the second plurality of schema instances with a corresponding first one of the first plurality of schema instances; and
second synchronization means for synchronizing a second one of the second plurality of schema instances with a corresponding second one of the first plurality of schema instances, wherein the first synchronization means operates independently of the second synchronization means.

19. The aggregate database instance of claim 17, wherein the first synchronization means comprises means for synchronizing the first one of the second plurality of schema instances with the corresponding first one of the first plurality of schema instances without interrupting operation of the second one of the second plurality of schema instances or the corresponding second one of the first plurality of schema instances.

20. The aggregate database instance of claim 12, further comprising:
first modification means for performing a first modification to a first one of the first plurality of schema instances;
second modification means for performing a second modification to a first one of the second plurality of schema instances without modifying any other ones of the second plurality of schema instances, the first and second modification being equivalent.

21. The aggregate database system of claim 20, wherein the first one of the first plurality of schema instances and the first one of the second plurality of schema instances implement a first schema definition;
wherein the first modification means comprises means for updating the first one of the first plurality of schema instances to implement a second schema definition that differs from the first schema definition; and
wherein the second modification means comprises means for updating the first one of the second plurality of schema instances to implement the second schema definition.

22. The aggregate database instance of claim 20, wherein the first modification means comprises means for modifying contents of the first one of the first plurality of schema instances and wherein the second modification means comprises means for modifying contents of the first one of the second plurality of schema instances.

23. A computer-implemented method for use with a computer system, the computer system including a plurality of database instances and an aggregate database instance including a plurality of elements corresponding to the plurality of database instances, the method comprising:
(A) synchronizing a first one of the plurality of database instances and a first one of the plurality of elements in the aggregate database instance without interrupting operation of any other ones of the plurality of database instances.

24. The method of claim 23, further comprising:
(B) synchronizing a second one of the plurality of database instances and a second one of the plurality of elements in the aggregate database instance without interrupting operation of any other ones of the plurality of database instances.

25. The method of claim 23, wherein the plurality of elements comprises a first plurality of schema instances.

26. The method of claim 25, wherein the plurality of database instances comprises a second plurality of schema instances, and wherein each of the first plurality of schema instances corresponds to at least one of the second plurality of schema instances.

27. The method of claim 23, wherein (A) comprises copying contents of the first one of the plurality of database instances into the first one of the plurality of elements in the aggregate database instance.

28. The method of claim 23, wherein (A) comprises copying contents of the first one of the plurality of elements in the aggregate database instance into the first one of the plurality of database instances.

29. The method of claim 23, wherein (C) comprises synchronizing a first one of the plurality of database instances and a first one of the plurality of elements in the aggregate database instance without interrupting synchronization of any other ones of the plurality of database instances.

30. The method of claim 23, wherein (C) comprises synchronizing a first one of the plurality of database instances and a first one of the plurality of elements in the aggregate database instance without interrupting updates of any other ones of the plurality of database instances.

31. A computer-implemented method for use with a computer system, the computer system including a plurality of database instances and an aggregate database instance including a plurality of elements corresponding to the plurality of database instances, the method comprising:
(A) performing a first modification to a first one of the plurality of database instances;
(B) performing a second modification to a first one of the plurality of elements, the first and second modification being equivalent;
wherein (A) and (B) are performed without modifying any of the plurality of elements except for the first one of the plurality of elements.

32. The method of claim 31, wherein the plurality of elements comprises a first plurality of schema instances.

33. The method of claim 32, wherein the plurality of database instances comprises a second plurality of schema instances, and wherein each of the first plurality of schema instances corresponds to at least one of the second plurality of schema instances.

34. The method of claim 31, wherein (A) comprises modifying the first one of the plurality of database instances to implement a new schema definition, and wherein (B) comprises modifying the first one of the plurality of elements to implement the new schema definition.

35. The method of claim 31, wherein (A) comprises modifying contents of the first one of the plurality of database instances, and wherein (B) comprises modifying contents of the first one of the plurality of elements.

36. The method of claim 31, wherein (A) is performed before (B).

37. The method of claim 31, wherein (A) is performed after (B).

38. The method of claim 31, further comprising:
(C) performing a third modification to a second one of the plurality of elements, the second and third modifications being equivalent.

39. The method of claim 38, wherein the first one of the plurality of database instances and the first one of the plurality of elements implement a first schema definition, wherein (A) comprises modifying the first one of the plurality of database instances to implement a second schema definition that differs from the first schema definition, wherein (B) comprises modifying the first one of the plurality of elements to implement the new schema definition, and wherein (C) comprises modifying the second one of the plurality of elements to implement the new schema definition.
